(19) United States
(12) Patent Application Publication
(10) Pub. No.: US 2020/0350575 A1
(43) Pub. Date: Nov. 5, 2020

(54) COMPOSITE FOR CATHODE OF LI-ION BATTERY, ITS PREPARATION PROCESS AND THE LI-ION BATTERY

(71) Applicant: Farasis Energy (Ganzhou) Co., Ltd., Ganzhou (CN)

(72) Inventors: Hongjian Liu, Ganzhou (CN); Michael Slater, Ganzhou (CN); Keith Kepler, Ganzhou (CN); Peng Liao, Ganzhou (CN)

(73) Assignee: Farasis Energy (Ganzhou) Co., Ltd., Ganzhou (CN)

(21) Appl. No.: 16/863,468

(22) Filed: Apr. 30, 2020

Related U.S. Application Data
(60) Provisional application No. 62/840,936, filed on Apr. 30, 2019.

(51) Int. Cl. H01M 4/505; H01M 10/0525; H01M 4/525; H01M 4/36; H01M 2/16; H01M 4/04

(52) U.S. Cl. CPC H01M 4/505; H01M 10/0525; H01M 4/0471; H01M 4/364; H01M 2/1673; H01M 4/525

(57) ABSTRACT

Disclosed herein is composite for the cathode of Li-ion battery comprising: a first component and a second component represented by LiNi_{0.5}Mn_{1.5}O₂; wherein the first component contains active material or surface treated active material, wherein the active material is represented by a formula Li₁₊ₐ(Ni_{1-b-c}Co_{b}Mn_{c})O₂, 0≤a≤0.5, 0≤b≤0.4, 0≤c≤0.6, with b+c<1; based on the total amount of the composite, the content of the second component is 1 wt % to 30 wt %. Also disclosed herein is a Li-ion battery comprising a cathode, an anode and a separator sandwiched therebetween, wherein the cathode contains the above mentioned composite. The present disclosure provides a cathode material for Li-ion batteries with greater high voltage stability, high voltage capacity retention, high energy density and greater cycle life than the existing material.

### PRIORITY CLAIM & CROSS REFERENCE

The present non-provisional application claims the benefits of the provisional application Serial No. U.S. 62/840,936 filed on Apr. 30, 2019 which is incorporated by reference herein in its entirety.

### TECHNICAL FIELD

The present disclosure relates to the field of Li-ion battery, in particular to a composite for cathode of Li-ion battery, its preparation process and the Li-ion battery.

### BACKGROUND

Conventional cathode active materials for lithium ion batteries are typically based on complex transition metal oxides in the form of Li₁₊ₐNa_{1-b-c}Co_{b}Mn_{c}O₂, frequently referred to as NCM. The choice of transition metals reflects a balancing of properties including structure stability, energy density, safety, and cost. Recently the demand for high energy, high power Li-ion battery from EV market has set up a focus on high voltage active cathode materials for next generation lithium-ion batteries. Conventional NCM materials are involved in side-reactions with electrolyte at higher operation voltage, resulting structural degradation and great cycle capacity loss. Whereas LiNi_{0.5}Mn_{1.5}O₄ spinel, or high voltage spinel (HVS), can offer high power capability with an operating voltage of ˜4.7 V, but with relatively lower capacity compared to conventional NCMs.

Thus a high capacity, long cycle life cathode material that is stabilized at high voltages is highly desirable.

### SUMMARY

The present disclosure aims to solve a problem of how to improve the stability and cycle life for a lithium ion battery at high voltages and provides a composite for cathode of Li-ion battery, its preparation process and the Li-ion battery. The composite shows improved high voltage capacity retention and long cycle life.

In the first aspect, the present disclosure provides a composite for the cathode of a Li-ion battery comprising:

a first component and a second component represented by LiNi_{0.5}Mn_{1.5}O₂;

wherein the first component contains active material or surface treated active material, wherein the active material is represented by a formula Li₁₊ₐ(Ni_{1-b-c}Co_{b}Mn_{c})O₂, 0≤a≤0.5, 0≤b≤0.4, 0≤c≤0.6with b+c<1;

based on the total amount of the composite, the content of the second component is 1 wt % to 30 wt %.

In the second aspect, the present disclosure provides a method for preparing a composite for the cathode of Li-ion battery, comprising: mixing a first component and a second component in proportion to obtain the composite;

wherein the first component contains active material or surface treated active material, the active material is represented by a formula Li₁₊ₐ(Ni_{1-b-c}Co_{b}Mn_{c})O₂, 0≤a≤0.5, 0≤b≤0.4, 0≤c≤0.6, with b+c<1; the second component is represented by LiNi_{0.5}Mn1.5O₂;

based on the total amount of the composite, the content of the second component is 1 wt % to 30 wt %.

In the third aspect, the present disclosure provides a composite obtained by the method in the present disclosure.

In the fourth aspect, the present disclosure provides a cathode of Li-ion battery comprising a cathode material layer containing a composite of the present disclosure.

In the fifth aspect, the present disclosure provides a Li-ion battery comprising a cathode, an anode and a separator sandwiched therebetween wherein the cathode contains a composite for the cathode of Li-ion battery comprising:

a first component and a second component represented by LiNi_{0.5}Mn_{1.5}O₂;

wherein the first component contains active material or surface treated active material, wherein the active material is represented by a formula Li₁₊ₐ(Ni_{1-b-c}Co_{b}Mn_{c})O₂, 0≤a≤0.5, 0≤b≤0.4, 0≤c≤0.6, with b+c<1;

based on the total amount of the composite, the content of the second component is 1 wt % to 30 wt %.

Thus the present disclosure provides a cathode material for Li-ion batteries with greater high voltage stability, high voltage capacity retention, high energy density and greater cycle life than the existing material.

### BRIEF DESCRIPTION OF THE DRAWINGS

FIG. 1 shows the first cycle voltage curve vs specific capacity (3V-4.95V) for the cells prepared from pristine HVS (Comparative Example 1-A) and NCM111 (Comparative Example 1-B) cathode materials.

FIG. 2 shows the second cycle discharge voltage curve vs capacity (3V-4.95V) for the cells prepared from two component mixed cathode materials with different weight percentage ratios of HVS and NCM111 relative to the total amount of the composite (Example 1-A to Example 1-C), and a pristine NCM111 (Comparative Example 1-B) cathode material as comparison.

FIG. 3 shows discharge capacity retentions (2V-4.6V) vs cycle number plots for the cells prepared from two component mixed cathode materials with different weight percentage ratios of HVS and NCM111 relative to the total amount of the composite (Example 1-A to Example 1-C), and a pristine NCM111 (Comparative Example 1-B) cathode material as comparison.

FIG. 4 shows discharge capacity retentions (2V-4.6V) vs cycle number plots for the cells prepared from mixed cathode materials with l0 wt % HVS and 90 wt % NCM111 (Example 1-B), mixed cathode materials with 10 wt % HVS and 90 wt % TR-NCM111 (0.6 wt % Sn-0.12 wt % B two component coated NCM) (Example 2), and a pristine NCM111 (Comparative Example 1-B) cathode material, and a surface treated pristine NCM111 material (Comparative Example 2) as comparison.

### DETAILED DESCRIPTION

Hereunder the embodiments of the present disclosure will be specified in details. It should be appreciated that the embodiments described here are only provided to describe and explain the present disclosure, but shall not be deemed as constituting any limitation to the present disclosure.

In the first aspect, the present disclosure provides a composite for the cathode of a Li-ion battery comprising:

a first component and a second component represented by LiNi_{0.5}Mn_{1.5}O₂;

wherein the first component contains active material or surface treated active material, wherein the active material is represented by a formula Li₁₊ₐ(Ni_{1-b-c}Co_{b}Mn_{c})O₂0≤a≤0.5, 0≤b≤0.4, 0≤c≤0.6, with b+c≤1;

based on the total amount of the composite, the content of the second component is 1 wt % to 30 wt %.

In a preferred embodiment of the present disclosure, preferably, the content of the second component is 5 wt % to 25 wt % based on the total amount of the composite.

In a preferred embodiment of the present disclosure, preferably, based on the total amount of the composite, the content of the first component is 70 wt % to 99 wt %. More preferably, based on the total amount of the composite, the content of the first component is 75 wt % to 95 wt %.

The inventors of the present disclosure find that in some embodiments of the present disclosure, the second component is within the limit range above, the higher the content of the second component (HVS), the better the effect of battery capacity retention and stability.

In a preferred embodiment of the present disclosure, preferably, the surface treated active material includes an active material and a coating on the active material containing a component B₂O₃ and/or a compound represented by a formula SnBₓO_{2+3x/2-y/2}F_{y}; wherein 0≤x≤5, 0<y<4+3x; wherein relative to the total amount of the active material, the weight percentage of Sn element is not more than 5 wt %,the weight percentage of B element is not more than 2 wt %. In some embodiments of the present disclosure, mixed cathode materials with the surface treated active material and the second component (HVS) showed high capacity, long cycle life and high stability at high voltages.

In a preferred embodiment of the present disclosure, preferably, the coating on the active material contains the compound represented by a formula SnBₓO_{2+x/2-y/2}F_{y}, wherein 0<x≤5, 0<y<4+3x; relative to the total amount of the active material, the weight percentage of Sn element is 0.2 wt % to 1.2 wt %, more preferably is 0.2 wt % to 0.8 wt %, still more preferably is 0.45 wt % to 0.75 wt %, most preferably is 0.6 wt %; the weight percentage of B element is 0.08 wt % to 0.5 wt %, more preferably is 0.08 wt % to 0.16 wt %, still more preferably is 0.1 wt % to 0.14 wt %, most preferably is 0.12 wt %. When the content of both B element and Sn element in the coating is within the still more preferably or most preferably range, the cycle life of two component is better than that of one component.

The inventors of the present disclosure also find that when the weight percent of Sn element is more than that of B element, a higher capacity, longer cycle life cathode material at high voltages (2-4.6V) will be got. Preferably, relative to the total amount of the base active material, the weight percentage of Sn element to the weight percentage of B element is 3:0.1-1.35, more preferably is 3:0.4-1.25, still more preferably is 3:0.4-0.8.

In a preferred embodiment of the present disclosure, preferably, relative to the total amount of the active material, the content of the coating is 0.1 wt % to 3 wt %, more preferably is 0.2 wt % to 1.7 wt %, still more preferably is 0.6 wt % to 0.8 wt %.

The inventors of the present disclosure find that the cathode electrodes based on mixtures of the second component (represented by HVS) and the first component (represented by NCM or TR-NCM), yield significant improvements over either material individually, and reflect complementary contributions of each material to the overall electrode performance. Another advantage of the mixture of two component is that the irreversible specific capacity of the cathode is a function of NCM or TR-NCM content, which provides a means for controlling the amount of lithium donated to the anode during the formation process.

In the second aspect, the present disclosure provides a method for preparing a composite for the cathode of Li-ion battery, comprising: mixing a first component and a second component in proportion to obtain the composite;

wherein the first component contains active material or surface treated active material, the active material is represented by a formula Li₁₊ₐ(Ni_{1-b-c}Co_{b}Mn_{c})O₂, 0≤a≤0.5, 0≤b≤0.4, 0≤c≤0.6, with b+c<1 the second component is represented by LiNi_{0.5}Mn_{1.5}O₂;

based on the total amount of the composite, the content of the second component is 1 wt % to 30 wt %.

In a preferred embodiment of the present disclosure, preferably, based on the total amount of the composite, the content of the second component is 5 wt % to 25%.

In a preferred embodiment of the present disclosure, preferably, based on the total amount of the composite, the content of the first component is 70 wt % to 99%, more preferably is 75 wt % to 95%.

In a preferred embodiment of the present disclosure, preferably, the method further includes the following steps to prepare the surface treated active material:

(1) mixing the active material with a phase component and/or a precursor of the phase component; and

(2) firing the mixture obtained in step (1);

wherein the phase component contains a component B₂O₃ and/or a compound represented by a formula SnBₓO_{2+3x/2-y/2}F_{y}, wherein 0≤x<5, 0<y<4+3x; the precursor of the phase component is selected from a group consisting of H₃BO₃, HBO₂ and SnF₂; the amount of the phase component and/or the precursor of the phase component makes that relative to the total amount of the active material, the weight percentage of Sn element is not more than 5 wt %, the weight percentage of B element is not more than 2 wt %.

In a preferred embodiment of the present disclosure, preferably, in step (1) the mixing may be dry mixing; or the wet mixing is performed in a solvent selected from water and methanol. When wet mixing is used, the amount of solvent can be just enough to dissolve the coating phase components or their precursors, i.e., according the solubility of the coating phase components or their precursors, the minimum amounts of solvent is required.

In a preferred embodiment of the present disclosure, preferably, in step (1) the mixing is performed in the presence of a milling media, the milling media is preferably zirconia.

In some embodiments of the present disclosure, preferably, when both B element and Sn element are involved in the coating, no matter the mixing is dry-mixed or wet mixed, the active material can be mixed with the phase components and/or a precursor for the phase components directly. In a preferred embodiment of the present disclosure, in step (1) mixing the active material with B₂O₃ or a precursor of B₂O₃ for 20-40 min to obtain a mixture first, and then mixing the mixture with SnO_{2-y/2}F_{y} or a precursor of SnO_{2-y/2}F_{y} for 1 hour to 3 hours.

In a preferred embodiment of the present disclosure, preferably, in step (1) the precursor of B₂O₃ is at least one of H₃BO₃ and HBO₂, the precursor of SnO_{2-y/2}F_{y} is SnF₂, in this case, 0<y<2.

In a preferred embodiment of the present disclosure, preferably, in step (2) the firing is performed at a temperature of 400° C. to 600° C. for 4 hours to 6 hours.

The specific advantages of this surface treated active material over the current art include the fact that the coating phase is insulating and stable to the electrolyte at high voltages and may minimize adverse reactions of the cathode material with the electrolyte at high voltages; it is Li-ion conductive and may minimize the impact of the coating layer on the material performance; it may allow for more uniform coating of the particles surface, and these compositions are chemically compatible with the active cathode material such that firing the materials together to make the coating layer does not adversely affect the structure or performance of the base active material. These unique combinations of characteristics lead to greatly improved stability of the layered type cathode materials of this invention at high voltages allowing for extended cycle life at high capacities.

In the third aspect, the present disclosure provides a composite obtained by the method in the present disclosure.

In the fourth aspect, the present disclosure provides a cathode of Li-ion battery comprising a cathode material layer containing a composite of the present disclosure.

In a preferred embodiment of the present disclosure, typically, the cathode comprises a current collector and a cathode material layer thereon, while the substantial difference between the cathode of the present disclosure and the prior cathode is that the cathode material layer of the cathode of the present disclosure contains the composite of the present disclosure.

In a preferred embodiment of the present disclosure, the current collector may be any current collector used in the art, such as aluminum foil, aluminum mesh and etc., the thickness of the current collector may be varied in a large range, such as 15-25 μm.

Except the composite of the present disclosure, the cathode material layer may contain any additives commonly used in the art; typically, the cathode material layer further contains a conductive agent and a binder. Wherein, the conductive agent may be any common conductive agent in the art, for example, the conductive agent may be one or more of conductive carbon black, graphite, graphene, carbon nano-materials and etc. The binder may be any common binder in the art, preferably, the binder is polyvinylidene fluoride (PVDF). The amount of the conductive agent and the binder may be varied in a large range, preferably, a weight ratio of the composite, the conductive agent and the binder is 70-98: 1-15: 1-15, more preferably is 90-95: 3-10: 2-10. In the present invention, the thickness of the positive electrode material layer may be varied in a large range, preferably the thickness of the cathode material layer is 30-150 μm, more preferably is 50-120 μm.

In a preferred embodiment of the present disclosure, the cathode can be prepared by the common method in the art, for example the method for preparation of the cathode comprising:

(i) providing a cathode slurry containing the composite, the conductive agent and the binder;

(ii) depositing the cathode slurry on the current collector and drying the obtained product so as to form a cathode material layer on the current collector.

In the method for preparation of the cathode, solvent used in the cathode slurry may be any solvent suitable for preparation the cathode slurry, for example, 1-methyl-2-pyrrolidone (NMP), The amount of the solvent may be varied in a large range, for example, the amount of the solvent would make the total concentration of the composite, the conductive agent and the binder be 20-70 wt %, preferably be 35-50 wt %. The slurry may be prepared by mixing all the materials in the solvent by introducing the materials in one time or step by step, preferably, the preparation process of the slurry comprising: mixing the binder with the solvent to form a binder solution, then adding the conductive agent into the binder solution, finally adding the second component and the first component step by step into the above solution and mixing for a certain time (such as 1-2h) to form the cathode slurry.

In step (ii) of the method above, the cathode slurry can be deposited on the current collector by any common means in the art such as by coating using a coater, then the current collector deposited with the cathode slurry would be dried to obtain the cathode, preferably a condition of the drying process includes: a temperature of 60-100° C., a time of 1-3 h.

In the fifth aspect, the present disclosure provides a Li-ion battery comprising a cathode, an anode, a polymer separator sandwiched therebetween, and an electrolyte, wherein the cathode contains a composite for the cathode of Li-ion battery comprising:

a first component and a second component represented by LiNi_{0.5}Mn_{1.5}O₂;

wherein the first component contains active material or surface treated active material, wherein the active material is represented by a formula Li₁₊ₐ(Ni_{1-b-c}Co_{b}Mn_{c})O₂, 0≤a≤0.5, 0≤b≤0.4, 0≤c≤0.6, with b+c<1;

based on the total amount of the composite, the content of the second component is 1 wt % to 30 wt %.

The anode typically is lithium metal electrode. The polymer separator may be any commonly used electrolyte separator in the art, such as porous polyolefin separator (like porous PP separator, porous PE separator). The electrolyte may be any electrolyte commonly used in the art, typically is an organic solution of lithium salt of which concentration may be 0.5-2 mol/L, the lithium salt may be one or more of LiPF₆, LiClO₄, LiBF₄, LiBOB, LiN(SO₂CF₃)₂, and etc. Organic solvent used in the electrolyte may be one or more of ethylene carbonate (EC), diethyl carbonate (DEC), dimethyl carbonate (DMC), ethyl methyl carbonate (EMC) and etc., preferably is a mixed solvent of EC and DEC with a weight ratio of 1:9 to 4:6.

Below the present disclosure is described in detail by referring to embodiments.

### COMPARATIVE EXAMPLE 1-A

The pristine cathode materials LiNi₀₅Mn_{1.5}O₂ (HVS) powder were weighed out to prepare electrode of the cathode materials, acetylene black, graphite and polyvinylidene difluoride binder in the formulation of 94.5%/2.5%/1%/2%.

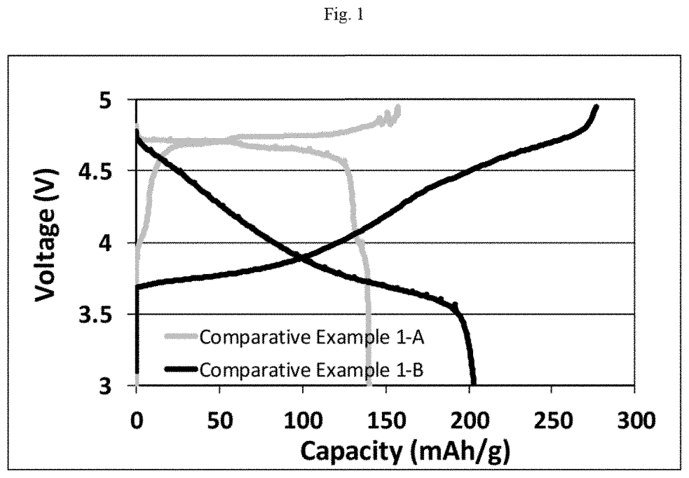

The electrode fabricated above were cut to ⅝ diameter disks using a punch press and electrochemically characterized in CR2032 coin cells. A CR2032 coin cell was assembled with a cathode fabricated from cathode material, a porous polyolefin separator, a lithium metal anode electrode, and an electrolyte of 1.2 M LiPF₆ in EC/DEC (ethylene carbonate/ethyl methyl carbonate) in a 3:7 ratio by weight. The coin cell was tested using 10 mA units of LAND Battery Testing System at 30° C. using a constant current between 3-4.95V, the test results were shown in FIG. 1.

### COMPARATIVE EXAMPLE 1-B

The pristine cathode materials LiNi_{0.5}Mn_{1.5}O₂ powder were weighed out to prepare electrode of the cathode materials, acetylene black, graphite and polyvinylidene difluoride binder in the formulation of 94.5%/2.5%/1%/2%.

The electrode fabricated above were cut to ⅝ diameter disks using a punch press and electrochemically characterized in CR2032 coin cells. A CR2032 coin cell was assembled with a cathode fabricated from cathode material, a porous polyolefin separator, a lithium metal anode electrode, and an electrolyte of 1.2 M LiPF₆ in EC/DEC (ethylene carbonate/ethyl methyl carbonate) in a 3:7 ratio by weight. The coin cell was tested using 10 mA units of LAND Battery Testing System at 25° C. using a constant current between 3-4.95V, the test results were shown in FIG. 1.

FIG. 1 is a graphical representation of the first cycle voltage curve vs specific capacity of (3V-4.95V) for the cells prepared from pristine HVS (Comparative Example 1-A) and NCM111 (Comparative Example 1-B) cathode materials. It showed the specific capacity and voltage range of pristine NCM111 and pristine HVS.

### EXAMPLE 1

Mixed cathode materials with different weight percentage ratios of LiNi_{0.5}Mn_{0.5}O₂(HVS) and Li₁₊ₐNi_{1-b-c}Co_{b}Mn_{c}O₂ (with a=0, b=c=⅓, NCM111).

As an example, 0.53 g acetylene black and 0.21 g graphite were added to 4.23 g premade binder solution (with a concentration of 10% polyvinylidene difluoride), mixed using an overhead mixer for 30 min, and then the weighed components were slowly added into the solution with the order of HVS, NCM111 and mixed using an overhead mixer for 1-2 hours to form slurry. wherein the dosage of HVS and NCM111 were shown in Table 1. The slurry was coated on the aluminum foil collector with a coater and was dried at 85° C. for 2 hours to form a cathode material layer on the collector, thus obtain cathode. The CR2032 coin cells were respectively assembled with a cathode fabricated from cathode material, a porous polyolefin separator, a lithium metal anode electrode, and an electrolyte of 1.2 M LiPF₆ in EC/DEC (ethylene carbonate/ethyl methyl carbonate) in a 3:7 ratio by weight.

TABLE 1
Mixed cathode materials with different weight percentage
ratios of HVS and NCM111 prepared in Example 1,
wherein a target of 20 g composite.

| Example | HVS(wt %) | NCM111(wt %) | HVS (g) | NCM111 (g) |
|---|---|---|---|---|
| Example | 5 | 95 | 1 | 19 |
| 1-A | | | | |
| Example | 10 | 90 | 2 | 18 |
| 1-B | | | | |
| Example | 25 | 75 | 5 | 15 |
| 1-C | | | | |

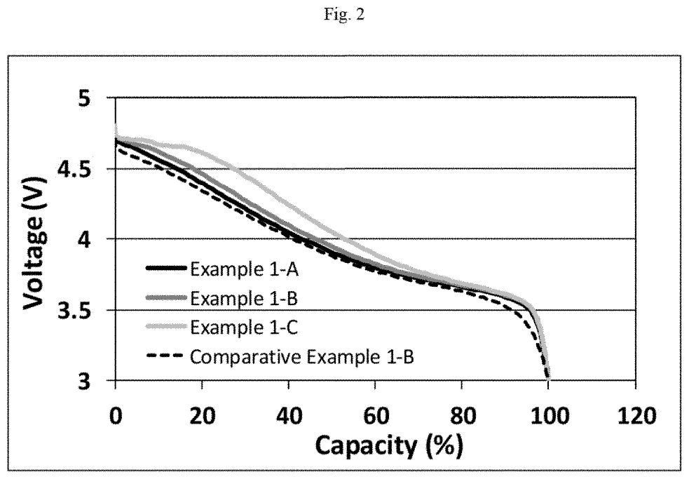

The coin cells above (Example 1-A to Example 1-C, Comparative Example 1-B) were tested using 10 mA units of LAND Battery Testing System at 30° C. using a constant current between 3-4.95V, the test results were shown in FIG. 2.

FIG. 2 is a graphical representation of the second cycle discharge voltage curve vs capacity for pristine NCM111 material, and mixed cathode materials with the above specific weight percentage ratios of HVS and NCM111 listed in Table 1, it showed the advantages of delivering higher capacity and power from the mixed cathode materials compared to pure NCM111. Furthermore, by comparing Example 1-A to Example 1-C, it can be seen that the higher the content of the second component (HVS), the slower the battery capacity decreases.

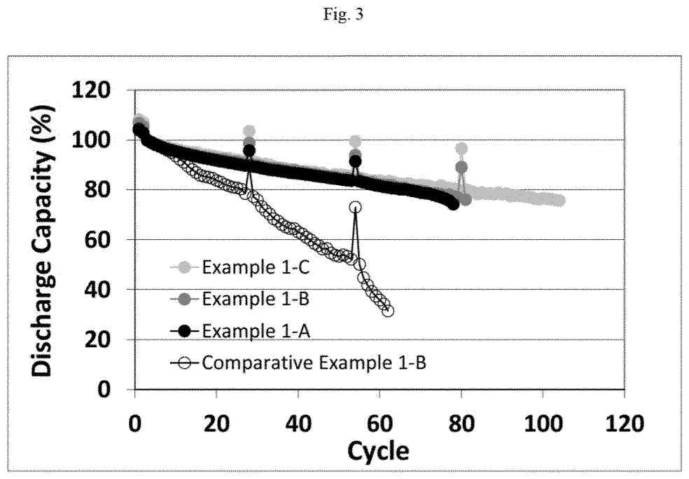

The coin cells above (Example 1-A to Example 1-C, Comparative Example 1-B) were tested using 10 mA units of LAND Battery Testing System at 30° C. using a constant current between 2-4.6V, C/15 two formation cycles, C/7 regular cycles, the test results were shown in FIG. 3.

FIG. 3 is a graphical representation of the discharge capacity retention vs cycle number plots of pristine NCM111 material, and mixed cathode materials with the above specific weight percentage ratios of HVS and NCM111 listed in Table 1, it showed improved high voltage capacity retention from the mixed cathode materials compared to pure NCM111. Furthermore, by comparing Example 1-A to Example 1-C, it can be seen that the higher the content of the second component (HVS), the better the effect of maintaining high voltage capacity.

TABLE 2
The first cycle charge/discharge cycle capacity and Energy density, and coulomb efficiency
of pristine and mixed cathode materials (3-4.95 V)

| | Data | C1 | D1 | Eff.1 | C1 | D1 |
|---|---|---|---|---|---|---|
| Materials | From | (mAh/g) | (mAh/g) | (%) | (Wh/kg) | (Wh/kg) |
| Comparative | Measured | 158 | 140 | 89 | 741 | 647 |
| Example 1-A: | | | | | | |
| Pristine HVS | | | | | | |
| Comparative | Measured | 277 | 203 | 73 | 1155 | 806 |
| Example 1-B: | | | | | | |
| Pristine | | | | | | |
| NCM111 | | | | | | |
| Example 1-A: | Calculated* | | | | | 798* |
| 5 wt % HVS- | Measured | 280 | 204 | 73 | 1172 | 817 |
| 95 wt % | | | | | | |
| NCM111 | | | | | | |
| Example 1-B: | Calculated* | | | | | 790* |
| 10 wt % HVS- | Measured | 270 | 200 | 74 | 1134 | 807 |
| 90 wt % | | | | | | |
| NCM111 | | | | | | |
| Example 1-C: | Calculated* | | | | | 766* |
| 25 wt % HVS- | Measured | 290 | 187 | 65 | 1244 | 770 |
| 75 wt % | | | | | | |
| NCM111 | | | | | | |

*Numbers are calculated using the weight percent ratios of the blends, and the measured values for pristine HVS (647 Wh/kg) and NCM (806 Wh/kg).

From the table 2, it can be seen that mixed cathode materials practically delivered higher capacity and energy density than calculated numbers from actual delivery values of pure HVS and NCM111. Furthermore, the mixed cathode materials with 5 wt % HVS and 95 wt % NCM111 achieved capacity and energy density higher than that of pure NCM111. And the mixed cathode materials showed improved cycle stability.

### COMPARATIVE EXAMPLE 2

The surface-treated cathode material Li₁₊ₐNi_{1-b-c}Co_{b}Mn_{c}O₂, with a a=0, b=c=⅓ (LiNi_{1/3}Co_{1/3}Mn_{1/3}O₂, NCM111) powder were weighed out to prepare electrodes of the cathode materials, acetylene black, graphite and polyvinylidene difluoride binder in the formulation of 94.5%/2.5%/1%/2%.

Wherein the method or procedure for preparation of the surface-treated cathode material contains: the process of two-component coating on the surface of the base material NCM111 was carried out through a solid-state reaction method, using tin fluoride (SnF₂) and boric acid (H₃B₃) as coating agents. As one specific example, the coating of 0.6 wt % Sn and 0.12 wt % B relative to the total weight of the base material NCM111 is described. 60 grams of NCM111 were weighted and placed into a wide-mouth plastic jar. Approximately 25 grams of zirconia milling media cylinders were added to the jar. The amounts of SnF₂ and H₃BO₃ required to give a coating of 0.6 wt % Sn and 0.12 wt % B relative to the weight of NCM111, respectively, were calculated. From the reported solubility of H₃BO₃ and SnF2 in water, the minimum amounts of water required to dissolve each compound were calculated. 0.4118 grams of boric acid was weighed out, and dissolved in 8.7392 grams of distilled water. This was added to the jar with the cathode material and milling media. The jar was rolled for 30 minutes using roll-miller. Meanwhile 0.4752 grams of tin fluoride were dissolved in 1.3575 grams of distilled water. The tin fluoride solutions were added to the jar, and tumbling was continued for 2 hours. The jars with contents were placed in a vacuum oven at approximately 85° C. to dry for 12 hours. Next the contents of the jar were placed in an alumina crucible and heated in air in a 400° C. oven for 5 hours. The final products were sieved through 50 gm using an Octagon 200 Test Sieve Shaker with Standard Test Sieve to remove large particles prior to coating the electrodes.

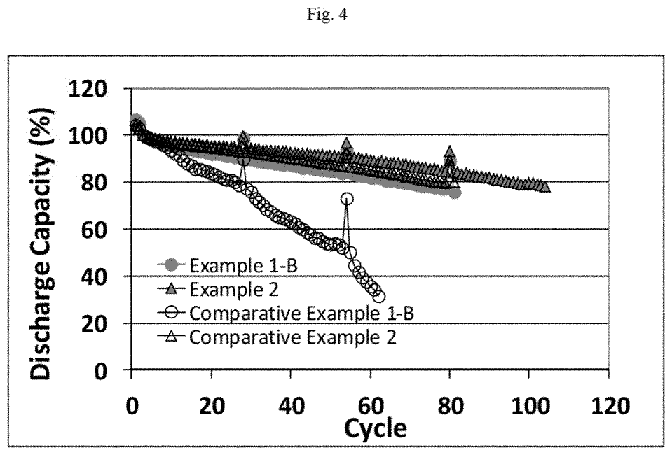

The electrode fabricated above were cut to ⅝ diameter disks using a punch press and electrochemically characterized in CR2032 coin cells. A CR2032 coin cell was assembled with a cathode fabricated from cathode material, a porous polyolefin separator, a lithium metal anode electrode, and an electrolyte of 1.2 M LiPF₆ in EC/DEC (ethylene carbonate/ethyl methyl carbonate) in a 3:7 ratio by weight. The coin cells was tested using 10 mA units of LAND Battery Testing System at 30° C. using a constant current between 2-4.6V, C/15 two formation cycles, C/7 regular cycles, the test results were shown in FIG. 4.

### EXAMPLE 2

Electrode with mixed cathode materials of 10 wt % HVS (Comparative Example 1-A) and 90 wt % TR-NCM111 (Comparative Example 2) using the method described in Example 1.

The coin cells was tested using 10 mA units of LAND Battery Testing System at 300 C using a constant current between 2-4.6V, C/15 two formation cycles, C/7 regular cycles, the test results were shown in FIG. 4.

FIG. 4 is a graphical representation of the cycle life capacity retention (2V-4.6V) vs cycle number plots of mixed cathode materials with 10 wt % HVS and 90 wt % NCM111, mixed cathode materials with 10 wt % HVS and 90 wt % TR-NCM111, pristine NCM111 material, and surface treated pristine NCM111 material, it showed improved high voltage capacity retention from mixed cathode materials compared to pure NCM111 or TR-NCM111, and mixed cathode materials with 10 wt % HVS and 90 wt % TR-NCM111 showed better high voltage capacity retention than that of mixed cathode materials with 10 wt % HVS and 90 wt % NCM111.

TABLE 3
Two Components of Sn and B Coated active Material
LiNi_{0.5}Co_{0.2}Mn_{0.3}O₂ (NCM111) with Different
Sn, B Coating Weight Percentages

| | active Material | | |
|---|---|---|---|
| Example | Weight (g) | Sn(wt %) | B(wt %) |
| Example 2-A | 60 | 0.6 | 0.12 |
| Example 2-B | 60 | 0.4 | 0.16 |
| Example 2-C | 60 | 1.2 | 0.5 |
| Example 2-D | 60 | 0.6 | 0 |
| Example 2-E | 60 | 0 | 0.12 |

The coin cells above (Example 2-A to Example 2-E, Comparative Example 1-B) were tested using 10 mA units of LAND Battery Testing System at 30° C. using a constant current between 2-4.6V, C/15 two formation cycles, C/7 regular cycles, the test results indicate that mixed cathode materials of 5 wt % HVS and 95 wt % TR-NCM111 showed greater high voltage capacity retention than that of mixed cathode materials of 5 wt % HVS and 95 wt % NCM111. Furthermore, by comparing the high voltage capacity retention of Example 2-A to Example 2-E, when mixed cathode materials with weight percentages of Sn and B are within the still more preferably or most preferably range, showing improved high voltage capacity and capacity retention, like 0.6 wt % Sn and 0.12 wt % B (Example 2-A) showed the best high voltage capacity and capacity retention, and then the test results of 0.4 wt % Sn and 0.16 wt % B (Example 2-B), 0.6 wt % Sn (Example 2-D)and 0.12 wt % B (Example 2-E). And mixed cathode materials of Example 2 showed better high voltage capacity retention than that of mixed cathode materials of Example 1.

1. A composite for the cathode of Li-ion battery comprising:
a first component and a second component represented by LiNi_{0.5}Mn_{1.5}O₂;
wherein the first component contains active material or surface treated active material, wherein the active material is represented by a formula Li₁₊ₐ(Ni_{1-b-c}Co_{b}Mn_{c})O₂, 0≤a≤0.5, 0≤b≤0.4, 0≤c≤0.6, with b+c<1;
based on the total amount of the composite, the content of the second component is 1 wt % to 30 wt %.

2. The composite of claim 1, wherein based on the total amount of the composite, the content of the second component is 5 wt % to 25 wt %.

3. The composite of claim 1, wherein based on the total amount of composite, the content of the first component is 70 wt % to 99 wt %.

4. The composite of claim 1, wherein the surface treated active material includes an active material and a coating on the active material containing a component B₂O₃ and/or a compound represented by a formula SnBₓO_{2+3x/2-y/2}F_{y}, wherein 0≤x≤5, 0<y<4+3x;
wherein relative to the total amount of the active material, the weight percentage of B element is not more than 2 wt %, the weight percentage of Sn element is not more than 5 wt %.

5. The composite of claim 4, wherein the coating on the active material contains the compound represented by a formula SnBₓO_{2+3x/2-y/2}F_{y}, wherein 0<x≤5, 0<y<4+3x; relative to the total amount of the active material, the weight percentage of Sn element is 0.2 wt % to 1.2 wt %, the weight percentage of B element is 0.08 wt % to 0.5 wt %.

6. The composite of claim 5, wherein the weight percentage of Sn element to the weight percentage of B element is 3:0.1-1.35.

7. The composite of claim 4, wherein relative to the total amount of the active material, the content of the coating is 0.1 wt % to 3 wt %.

8. A method for preparing a composite for the cathode of Li-ion battery, comprising: mixing a first component and a second component in proportion to obtain the composite;
wherein the first component contains active material or surface treated active material, the active material is represented by a formula Li₁₊ₐ(Ni_{1-b-c}Co_{b}Mn_{c})O₂, 0≤a≤0.5, 0≤b≤0.4, 0≤c≤0.6, the second component is represented by LiNi_{0.5}Mn_{1.5}O₂;
based on the total amount of the composite, the content of the second component is 1 wt % to 30 wt %.

9. The method of claim 8, wherein the method further includes the steps of:
(1) mixing the active material with a phase component and/or a precursor of the phase component; and
(2) firing the mixture obtained in step (1);
wherein the phase component contains a component B₂O₃ and/or a compound represented by a formula SnₓO_{2+3x/2-y/2}F_{y}; wherein 0≤x≤5, 0y<4+3x; the precursor of the phase component is selected from a group consisting of H₃BO₃, HBO₂ and SnF₂; the amount of the phase component and/or the precursor of the phase component makes that relative to the total amount of the active material, the weight percentage of Sn element is not more than 5 wt %, the weight percentage of B element is not more than 2 wt %.

10. The method of claim 9, wherein in step (1) the mixing is dry mixing; or the mixing is performed in a solvent selected from water and methanol.

11. The method of claim 9, wherein the mixing is performed in the presence of a milling media.

12. The method of claim 11, wherein the milling media is zirconia.

13. The method of claim 9, wherein in step (1) mixing the active material with B₂O₃ or a precursor of B₂O₃ for 20-40 min to obtain a mixture first, and then mixing the mixture with SnO_{2-y/2}F_{y} or a precursor of Sn_{2-y/2}F_{y} for 1 hour to 3 hours.

14. The method of claim 13, wherein the precursor of B₂O₃ is at least one of H₃BO₃ and HBO₂, the precursor of SnO_{2-y/2}F_{y} is SnF₂.

15. The method of claim 9, wherein in step (2) the firing is performed at a temperature of 400° C. to 600° C. for 4 hours to 6 hours.

16. A Li-ion battery comprising a cathode, an anode and a separator sandwiched therebetween, wherein the cathode contains the composite of claim 1.
